(19) United States
(12) Patent Application Publication
(10) Pub. No.: US 2016/0253378 A1
(43) Pub. Date: Sep. 1, 2016

(54) PRACTICAL MODULAR FINITE AUTOMATION

(71) Applicant: Cisco Technology, Inc., San Jose, CA (US)

(72) Inventors: Itay Marom, Herzliya (IL); Hanoch Haim, Tel Mond (IL); Nicholas Read Leavy, Limpsfield (GB); Kobi Kobi Vaknin, Yavne (IL)

(21) Appl. No.: 14/632,470

(22) Filed: Feb. 26, 2015

(51) Int. Cl. G06F 17/30

(52) U.S. Cl. CPC G06F 17/30424; G06F 17/30516

(57) ABSTRACT

A system, computer-readable media, and methods are disclosed for searching a data stream for one or more regular expressions. The method can include receiving a data stream and a regular expression and parsing the regular expression to create a prefix portion and a suffix portion. The method can also include executing a first search of at least a portion of the data stream for the prefix portion using a first search algorithm, the first search algorithm being stored in a computer readable medium and executed by a processor. The method also include executing a second search of at least a portion of the data stream for the suffix portion using a second search algorithm, the second search algorithm being stored in a computer readable medium and executed by a processor. Further, the method includes determining whether the data stream contains the regular expression based on the first search and the second search.

### TECHNICAL FIELD

The present disclosure relates generally to system and methods for searching data streams.

### BACKGROUND

Searching data streams for characters strings places increasingly large burdens on computer processors and networks. There are a large number of different applications that require searching data streams. Examples include search engines that need to quickly search the text of millions of webpages to return a result, network routers that need to parse packets and search for character sequences, and many others. A number of different solutions have been presented. However, the solutions often present trade-offs. Some approaches process searches fast but use very large amounts of memory, others process slowly but use less memory.

Two exemplary approaches are deterministic finite automaton (DFA) and nondeterministic finite automaton (NFA). DFA provides greater performance but reduced scalability, and also can consume large amounts of memory that cannot be easily predicted. This leads to a problem where processing search requests on a large number of data streams in parallel can lead to run-away memory consumption. NFA, on the other hand, offers predictable, compact memory usage, but slower performance.

### BRIEF DESCRIPTION OF THE DRAWINGS

FIG. 1 is a diagram of an example environment for searching data streams.

FIG. 2 illustrates an exemplary method for searching for a regular expression.

FIG. 3 illustrates an exemplary method for parsing a regular expression.

FIG. 4 illustrates an exemplary system architecture for executing modular finite automaton.

FIG. 5 illustrates an exemplary computer system for executing modular finite automaton.

FIG. 6 illustrates an exemplary flowchart of traverser logic.

Like reference numbers and designations in the various drawings indicate like elements.

### DESCRIPTION OF EXAMPLE EMBODIMENTS

### Overview

In accordance with one aspect, the present disclosure is directed to a system for searching a data stream for one or more regular expressions, comprising a network interface configured to receive the data stream and a processor. The processor is configured to obtain a regular expression, parse the regular expression to create a prefix portion and a suffix portion, execute a first search of at least a portion of the data stream for the prefix portion using a first search algorithm, execute a second search of at least a portion of the data stream for the suffix portion using a second search algorithm, and determine whether the data stream contains the regular expression based on the first search and the second search.

In another aspect, the disclosure relates to a method for searching a data stream for one or more regular expressions. The method can include receiving a data stream and a regular expression and parsing the regular expression to create a prefix portion and a suffix portion. The method can also include executing a first search of at least a portion of the data stream for the prefix portion using a first search algorithm, the first search algorithm being stored in a computer readable medium and executed by a processor. The method also include executing a second search of at least a portion of the data stream for the suffix portion using a second search algorithm, the second search algorithm being stored in a computer readable medium and executed by a processor. Further, the method includes determining whether the data stream contains the regular expression based on the first search and the second search.

In another aspect, a computer readable medium is disclosed comprising instructions which, when executed by a processor, performs a method comprising receiving a data stream and a regular expression and parsing the regular expression to create a prefix portion and a suffix portion. The computer readable medium also includes instructions which, when executed, perform a method including executing a first search of at least a portion of the data stream for the prefix portion using a first search algorithm, the first search algorithm being stored in a computer readable medium and executed by a processor; executing a second search of at least a portion of the data stream for the suffix portion using a second search algorithm, the second search algorithm being stored in a computer readable medium and executed by a processor; and determining whether the data stream contains the regular expression based on the first search and the second search.

### Example Embodiments

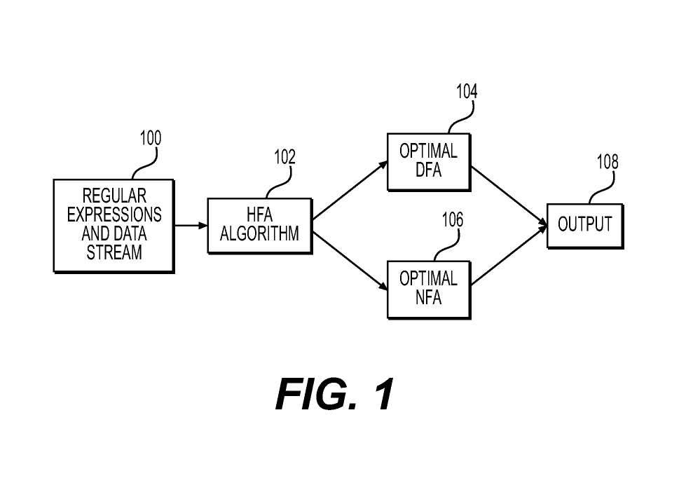

FIG. 1 is a diagram of an example environment for searching data streams. In FIG. 1, a computer processor module 100 receives a regular expression and a data stream. The computer processor can be any type of processor, such as those found in a router, network switch, a cloud computing environment, server, or any other type of computing unit. A regular expression is any sequence of characters that form a search pattern. The data stream likewise can be any type of data stream, such as the header, payload, and/or data portion of a network packet, a word processing document, a voice over IP telephone call, and others.

The regular expression serves as a search string to locate within the data stream. As an example, assume that a search will be performed to locate the regular expression john.*doe. In this example, the .* portion of the regular expression serves as a wildcard, indicating that zero or more characters of any type can be between the john portion and the doe portion and still result in a match. In some applications, a large number of regular expressions can be searched for in a single data stream. For example, a network router could examine a network packet to search for the webpage addresses for a large number of webpages to classify packet traffic, assign priorities to different types of network traffic, and route the data packets. Other examples include searching for binary search strings or any other series of characters depending on the type of data being analyzed. Executing each search in series, one after the other, takes longer. Instead, the searches can be executed in parallel on the data stream by searching for multiple regular expressions concurrently. In some embodiments, thousands of searches for regular expressions can be executed in parallel.

The regular expression(s) and data streams are provided to a modular finite automaton (HFA) algorithm 102. In one exemplary embodiment, the HFA algorithm can be a network based application recognition (NBR) HFA algorithm used in network routing to parse packets as part of the process of classifying packets and assigning an appropriate quality of service to the packets. Network routers can perform deep packet inspection to trace or classify various types of network traffic. The network routers, and other network equipment, can scan large numbers of packets quickly to try and match packets with known regular expressions while using the least amount of memory possible. In other examples, the HFA algorithm need not be used in network routing applications. The HFA algorithm uses a combination of DFA and NFA processing, depending on the portion and complexity of the regular expression, as described below.

In particular, the HFA algorithm parses the regular expression to identify any problematic portion that would cause a DFA algorithm to enter a state of consuming large memory resources or possibly even run-away amounts of memory. As an example, the HFA algorithm identifies wildcards as problematic for use with a DFA algorithm. Wildcards can be any portion of a search string that results in a large number of possible results. Continuing with the example above of a regular expression as john*.doe, the john portion will provide a match when those four characters appear in the data stream in order. DFA quickly handles this type of regular expression without significant memory usage, but it slows considerably and consumes memory upon encountering the *. portion, which is an example of a wildcard.

The HFA portion creates both a prefix and a suffix in the regular expression. In this example, john serves as the prefix, and *.doe serves as the suffix. The prefix portion enters an optimal DFA algorithm at 104. The system of FIG. 1 is modular, so that the code required to execute the DFA algorithm can be easily updated to the most recent version, also referred to as an optimal version, without needing to change either the HFA module 102 or the NFA module 106. Similarly, the HFA module 102 and/or NFA module 106 can be changed independently without other system changes. In addition, the modular approach allows other tools such as modular DFA or trie data structures to also be implemented.

The optimal DFA module 104 searches the data stream for the prefix portion of the regular expression. Upon finding a match, control passes to the optimal NFA module 106 to continue searching for the suffix portion. Upon finding a match of the suffix portion, output module 108 receives an indication of the match for the regular expression. Searching can then continue for repeated instances of the regular expression in the data stream.

In one embodiment, strings that begin with a wildcard expression or other regular expression that can be better handled by the NFA algorithm can be sent directly from the HFA module 102 to the optimal NFA module 106. Likewise, some strings can be completely handled by the DFA algorithm, such as where no wildcard expression exists, and the HFA algorithm 102 therefore passes control directly to the optimal DFA algorithm 104 and ultimately output 108.

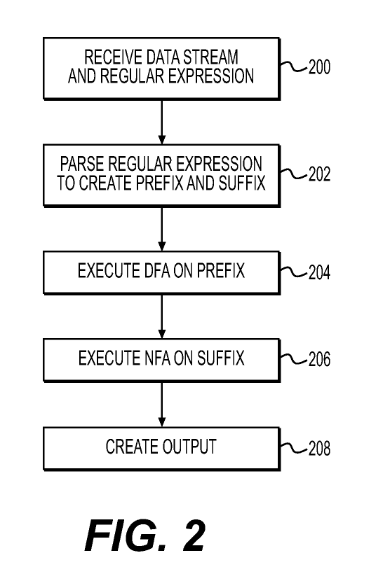

Reference will now turn to FIG. 2, which illustrates an exemplary method for searching for a regular expression. The method of FIG. 2 can be executed by any type of computing device as a search algorithm, such as a network router or switch performing deep packet inspection on network packets.

At step 200, the network component receives a data stream and a regular expression. The data stream can be from a network transmission of any type or from a file store on the network component. Similarly, the regular expression can be received over a network connection or stored in memory by the network component. In one embodiment, the network component simultaneously executes the algorithm to search for a plurality of regular expressions in a data stream.

At step 202, the network component parses the regular expression to create a prefix portion and a suffix portion. In one embodiment, a plurality of suffix portions can be created. The division between a prefix portion and suffix portion can be based on any portion of the regular expression that would be problematic to execute by either a first or second search algorithm. For example, a wildcard expression can lead to large memory consumption by the DFA algorithm. In this example, the prefix portion can include the regular expression up to the wildcard, and the suffix portion can include the portion of the regular expression that includes and follows a wildcard.

At step 204, the network component executes a first search algorithm on the prefix portion of the regular expression. The first search algorithm can be, for example, the DFA algorithm. Upon finding a match for the prefix within the data stream, control passes to execute a second search algorithm on the suffix portion of the regular expression at step 206. For example, a NFA algorithm executes to locate the suffix portion within the portion of the data stream beginning after the portion in which the prefix portion was located by the first algorithm.

Next, at step 208, the network component creates output indicating a match of the regular expression. The match can also include other contextual information, such as the portion of the data stream containing the regular expression. The network component then repeats the algorithm of FIG. 2 to search for additional matches of the regular expression. Although DFA has been described as the first search algorithm and NFA described as the second search algorithm, it will be appreciated that any number of additional search algorithms can also be used.

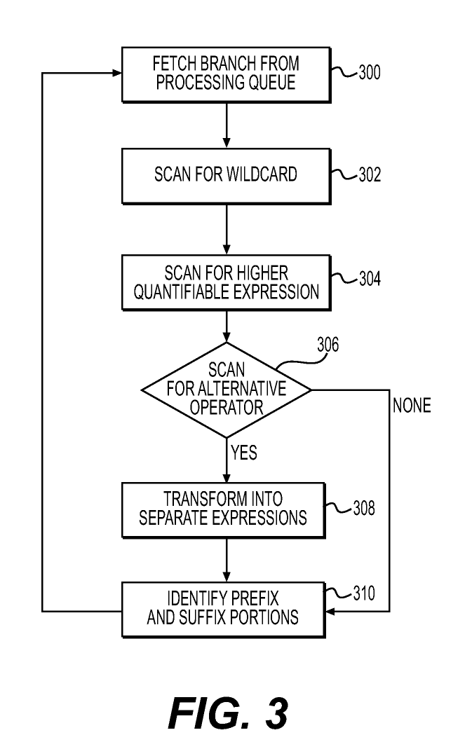

FIG. 3 illustrates an exemplary method for parsing a regular expression. In the example of FIG. 3, an abstract syntax tree can be constructed from the regular expression to serve as the basis for parsing. At step 300, the network component fetches a branch of the abstract syntax tree from the processing queue. In one example, the first fetched portion can be the root of the abstract syntax tree. Next, at step 302, the network component scans the abstract syntax tree for a wildcard character. The wildcard can be .*, although other examples are also possible. Then, the network component scans up the abstract syntax tree for higher quantifiable expressions. For example, an expression hello(from.*Israel)? serves as a wildcard and the expression can be split into two portions: hello(from and .*Israel. However, splitting the expression in this manner loses the regex operator “?” for the . *Israel portion, so the algorithm can search to find a higher quantifiable expression that contains the wildcard. In this example, the algorithm will indicate the prefix include hello and the suffix includes (from.*Israel)?.

Next, the network component scans the abstract syntax tree for an alternate operator, such as an “or” operator represented by 1. If an alternate operator is located, the regular expression can be transformed into separate expressions at step 308. For example, the regular expression abc(x|y.*z)qrz being processed through the method of FIG. 3 would identify the abc portion as the prefix, the qrz portion as the suffix, and the “or” operator at step 310. The expression would therefore be spilt into two expressions having the form abcxqrz|abcy.*zqrz. With P representing the prefix portion and S representing the suffix, the result is more simply stated as PxS|Py.*zS. The PxS portion and the Py.*zS portions can then both be placed in the queue, and the process can repeat as needed.

Additional illustrative examples will now be provided. Assume the regular expression is abc.*def. The prefix in this example is abc, and the suffix is .*def. The DFA algorithm searches the data stream for the abc portion of the regular expression, and, upon finding a match, the NFA, trie, or another tool searches the data stream for the suffix portion .*def. As another example, assume an input of abc(x|t.*z)pk1. The simplified representation of this regular expression is abcxpkl. The prefix portion is abct, and the suffix is .*zpk1. A first search algorithm attempts to locate the prefix portion abct in the data stream, and, upon finding a match, searches the suffix portion of .*zpk1 with a second search algorithm.

A third example of a regular expression FOO.*123[a-z]{3,5,}BARBAZ. It will be appreciated that may different examples are possible. The .* portion is a wildcard that means any characters any number of times. The [a-z] {3, 5} means any series of three to five characters of a-z in a row. In this exemplary pattern, the .* portion can be problematic for certain search algorithms, such as DFA, so the regular expression will be split into two parts. The prefix includes FOO, and the suffix includes the portion of .*123[a-z]{3,5,}BARBAZ. The network component searches the data stream for the prefix using, for example, DFA. When a match is found, the suffix is passed to another search algorithm such as NFA. As a result, a modular approach can be obtained by splitting the regular expression into two portions and using a modular approach of two search algorithms for each portion, where each module can be updated or replaced without impacting the rest of the system.

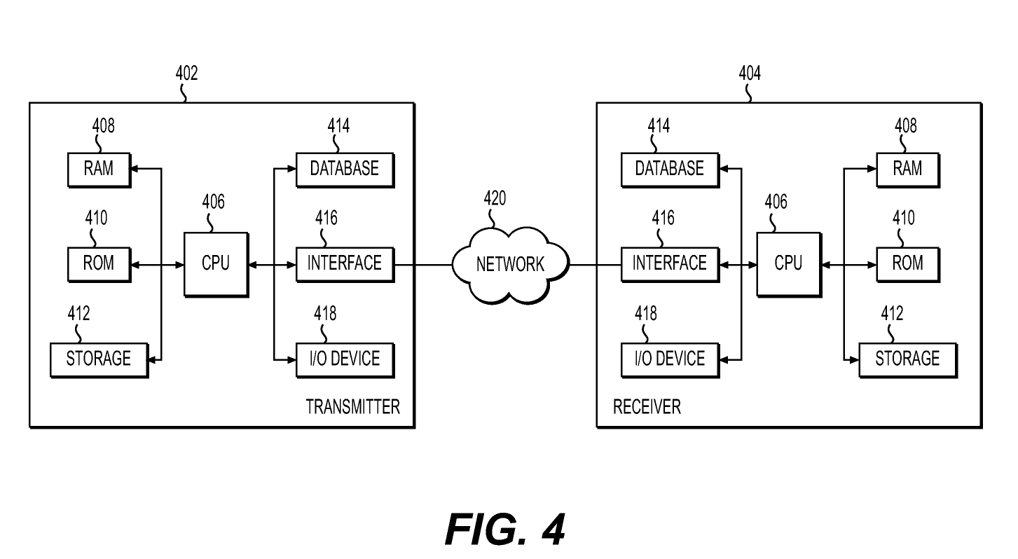

Reference will now turn to FIG. 4, which illustrates an exemplary system for executing modular finite automaton. In the exemplary environment of FIG. 4, a data transmitter 402 sends data to a receiver 404, and a network component within the network 420 performs deep packet inspection and the searching for a regular expression as described above. The network component can be a router, switch, mainframe, gateway, or other type of computing device. Transmitter 402 and receiver 404 may be, for example, network routing equipment, such as a router or a switch, a computer, a handheld device such as a smart phone, a printer, or any other electronic device that stores data or sends data over network 420.

Transmitter 402 and receiver 404 may, in one example, include substantially similar components. Transmitter 402 and receiver 404 may include one or more hardware components, such as a central processing unit (CPU) or microprocessor 406, a random access memory (RAM) module 408, a read-only memory (ROM) module 410, a memory or data storage module 412, a database 414, an interface 416, and one or more input/output (I/O) devices 418. Alternatively and/or additionally, transmitter 102 and receiver 104 may include one or more software media components such as, for example, a computer-readable medium including computer-executable instructions for performing methods consistent with certain disclosed embodiments. It is contemplated that one or more of the hardware components listed above may be implemented using software. For example, storage 412 may include a software partition associated with one or more other hardware components. While exemplary components have been described, devices implementing the searching techniques may include additional, fewer, and/or different components than those listed above.

CPU 406 may include one or more processors, each configured to execute instructions and process data to perform one or more functions. CPU 406 may implement the disclosed searching algorithms, or the algorithms may be implemented by interface 416, or a combination of the two. CPU 406 may be communicatively coupled to RAM 408, ROM 410, storage 412, database 414, interface 416, and I/O devices 418. CPU 406 may be configured to execute sequences of computer program instructions to perform various processes, including the searching techniques previously described. The computer program instructions may be loaded into RAM 408 for execution by CPU 406.

RAM 408 and ROM 410 may each include one or more devices for storing information associated with device operation. For example, ROM 410 may include a memory device configured to access and store information for searching data streams. RAM 408 may include a memory device for storing data associated with one or more operations of CPU 406 or interface 416. For example, ROM 410 may load instructions into RAM 408 for execution by CPU 406.

Storage 412 may include any type of mass storage device configured to store information that CPU 406 may need to perform processes consistent with the disclosed embodiments. For example, storage 412 may include one or more magnetic and/or optical disk devices, such as hard drives, CD-ROMs, DVD-ROMs, or any other type of mass media device. Alternatively or additionally, storage 412 may include flash memory mass media storage or other semiconductor-based storage medium.

Database 414 may include one or more software and/or hardware components that cooperate to store, organize, sort, filter, and/or arrange data. CPU 406 may access the information stored in database 414 to determine how a data stream will be searched, the regular expressions to search for, priority rules for handling a data stream, and others. Database 414 may store additional and/or different information than that listed above.

Interface 416 may include one or more components configured to transmit and receive data via a communication network 420, which may be the Internet, a local area network, a workstation peer-to-peer network, a direct link network, a wireless network, or any other suitable communication platform. For example, interface 416 may include one or more modulators, demodulators, multiplexers, demultiplexers, network communication devices, wireless devices, antennas, modems, and any other type of device configured to enable data communication via a communication network. According to one embodiment, interface 416 may be coupled to or include wireless communication devices, such as a module or modules configured to transmit information wirelessly using Wi-Fi or Bluetooth wireless protocols.

I/O devices 418 may include one or more components configured to communicate information with a component or user associated. I/O devices 418 may include a console with an integrated keyboard and mouse to allow user input. According to one embodiment, I/O devices 418 may be configured to receive one or more requests to stream data between a transmitter and a receiver. For example, the receiver 104 may be a personal computer or a smart phone, and I/O device 418 may be a touch screen that allows a user to request a webpage over network 420 from transmitter 402. The webpage may be provided in an encoded format, which receiver 404 may decode for display to a user on a display, which may also be an I/O device 418. I/O devices 418 may also include peripheral devices such as, for example, a printer, a user-accessible disk drive (e.g., a USB port, a floppy, CD-ROM, or DVD-ROM drive, etc.) to allow a user to input data stored on a portable media device, a microphone, a speaker system, or any other suitable type of interface device.

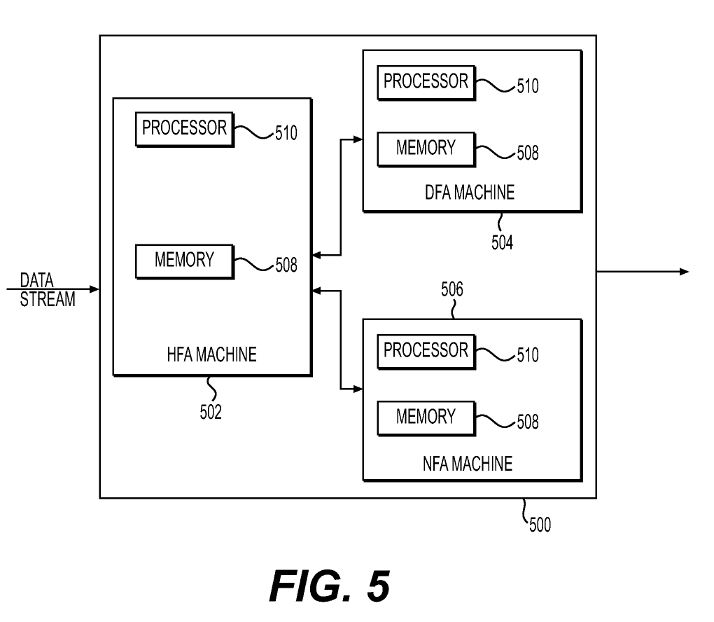

FIG. 5 illustrates an exemplary computer system for executing modular finite automaton. As described above, computer system 500 may exist within the network 420 as any type of network component. The computer system 500 includes a HFA machine 502, a DFA machine 504, and a NFA machine 506. In other embodiments using different search algorithms or additional search algorithms, different machines can be used. The machines 502, 504, 506 can include any combination of hardware and software. In some embodiments, the machines 502, 504, and 506 are separate portions of software residing on a single computing device. In other embodiments, the machines 502, 504, and 506 can be separate computing devices with their own processors 510 and memory 508. Although not illustrated, the machines 502, 504, and 506 can include other components of a computing system such as those illustrated in FIG. 4 with regard to the transmitter 402 and receiver 404.

The HFA machine 502, DFA machine 504, and NFA machine 506 can process a plurality of regular expressions in parallel. In some embodiments where computer system 500 is a network switch or router, the computer system 500 not only processes many regular expressions in parallel for a given data stream, but also processes many data streams in parallel which can also be search simultaneously for a plurality of regular expressions.

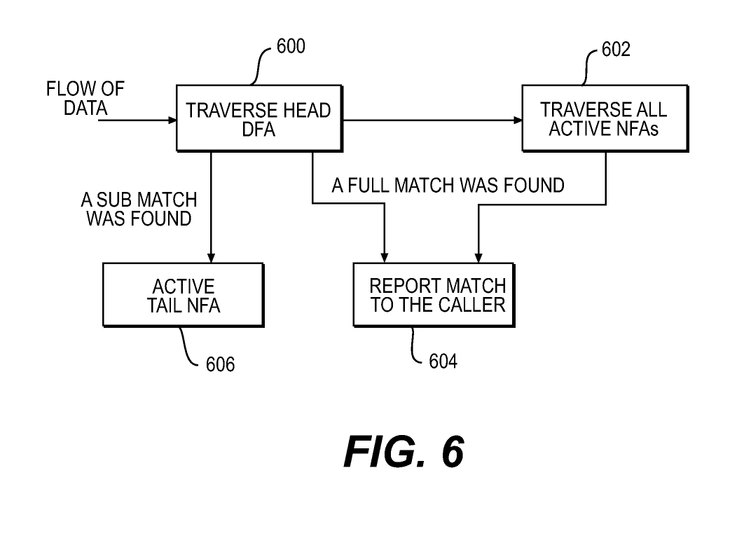

FIG. 6 illustrates an exemplary flowchart of traverser logic consistent with one embodiment. As illustrated, a data stream is received and the head traversed according to the DFA algorithm at step 600. If a sub-match is found up to, for example, a prefix portion such as a wildcard, then the suffix or tail portion can be analyzed according to the NFA algorithm at step 606. If a full match is found using DFA, the match will be reported to the calling software algorithm that executed the search at step 604. In addition, all active NFA searches can be performed at step 602, with full matches being reported as shown at step 604.

As an example, two regular expressions can be searched, .*abc and .*hello.*world, in a data stream of aaa.hello.bbb.world. The data stream will be fed through the DFA algorithm and all active NFA tails, if any. The prefix DFA search portions include .*abc and .*hello. In this example, aaa.hell will be processed by the DFA search with no actions, but upon processing the “o” in aaa.hello a match will be found for the prefix .*hello by the DFA search at step 600. The remaining portion, .*world, serves as the tail NFA 1. The NFA 1 will be marked as an active tail, and .bbb.worl will continue to be searched by the prefix DFA algorithm and the tail NFA algorithm. Finally, the “d” in .bbb.world will be processed by both the DFA algorithm and the NFA 1 algorithm, which will indicate a match for .*hello.*world.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

While this specification contains many specific implementation details, these should not be construed as limitations on the claims. Certain features that are described in this specification in the context of separate implementations may also be implemented in combination in a single implementation. Conversely, various features that are described in the context of a single implementation may also be implemented in multiple implementations separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

1. A system for searching a data stream for one or more regular expressions, comprising:
a network interface configured to receive the data stream;
a processor configured to:
obtain a regular expression;
parse the regular expression to create a prefix portion and a suffix portion;
execute a first search of at least a portion of the data stream for the prefix portion using a first search algorithm;
execute a second search of at least a portion of the data stream for the suffix portion using a second search algorithm; and
determine whether the data stream contains the regular expression based on the first search and the second search.

2. The system of claim 1, wherein the first search algorithm comprises a deterministic finite automaton.

3. The system of claim 1, wherein the second search algorithm comprises a nondeterministic finite automaton.

4. The system of claim 1, wherein the processor is further configured to scan the regular expression to identify one or more characters that are used to identify a transition from the prefix to the suffix, the one or more characters indicating a wildcard within the regular expression.

5. The system of claim 1, wherein the suffix portion comprises a plurality of suffix portions.

6. The system of claim 1, wherein the processor is further configured to replace the first search algorithm with an updated version without changing the second search algorithm.

7. The system of claim 1, wherein the processor is further configured to, in parallel, obtain a plurality of regular expressions, parse the plurality of regular expressions, and execute a first and second search using prefix and suffix portions of the plurality of regular expressions.

8. A method for searching a data stream for one or more regular expressions, comprising:
receiving a data stream and a regular expression;
parsing the regular expression to create a prefix portion and a suffix portion;
executing a first search of at least a portion of the data stream for the prefix portion using a first search algorithm, the first search algorithm being stored in a computer readable medium and executed by a processor;
executing a second search of at least a portion of the data stream for the suffix portion using a second search algorithm, the second search algorithm being stored in a computer readable medium and executed by a processor; and
determining whether the data stream contains the regular expression based on the first search and the second search.

9. The method of claim 8, wherein the first search algorithm comprises a deterministic finite automaton.

10. The method of claim 8, wherein the second search algorithm comprises a nondeterministic finite automaton.

11. The method of claim 8, wherein parsing the regular expression comprises:
scanning the regular expression to identify one or more characters that are used to identify a transition from the prefix to the suffix, the one or more characters indicating a wildcard within the regular expression.

12. The method of claim 8, wherein the suffix portion comprises a plurality of suffix portions.

13. The method of claim 8, wherein the first search algorithm comprises a modular component, and wherein the method further comprises replacing the first search algorithm with an updated version of the first search algorithm.

14. The method of claim 8, further comprising receiving a plurality of regular expressions and executing the method simultaneously using the plurality of regular expressions.

15. A computer readable medium comprising instructions which, when executed by a processor, perform a method for searching a data stream for one or more regular expressions, comprising:
receiving a data stream and a regular expression;
parsing the regular expression to create a prefix portion and a suffix portion;
executing a first search of at least a portion of the data stream for the prefix portion using a first search algorithm, the first search algorithm being stored in a computer readable medium and executed by a processor;
executing a second search of at least a portion of the data stream for the suffix portion using a second search algorithm, the second search algorithm being stored in a computer readable medium and executed by a processor; and
determining whether the data stream contains the regular expression based on the first search and the second search.

16. The computer readable medium of claim 15, wherein the first search algorithm comprises a deterministic finite automaton.

17. The computer readable medium of claim 15, wherein the second search algorithm comprises a nondeterministic finite automaton.

18. The computer readable medium of claim 15, further comprising instruction which, when executed by the processor, scan the regular expression to identify one or more characters that are used to identify a transition from the prefix to the suffix, the one or more characters indicating a wildcard within the regular expression.

19. The computer readable medium of claim 15, wherein the first search algorithm comprises a modular component that is replaced without changing the second search algorithm.

20. The computer readable medium of claim 15, further comprising receiving a plurality of regular expressions and executing the method simultaneously using the plurality of regular expressions.
